(19) United States
(12) Patent Application Publication
(10) Pub. No.: US 2026/0239196 A1
(43) Pub. Date: Aug. 13, 2026

(54) METHOD, APPARATUS, AND SYSTEM FOR UPDATING DISCONTINUOUS RECEPTION CONFIGURATION IN A WIRELESS DEVICE

(71) Applicant: Continental Automotive Technologies GmbH, Hannover (DE)

(72) Inventors: Rikin Shah, Langen, Hessen (DE); David Gonzalez Gonzalez, Egelsbach, Hessen (DE); Reuben George Stephen, Singapore (SG); Andreas Andrae, Frankfurt am Main (DE); Hojin Kim, Regensburg (DE); Shravan Kumar KALYANKAR, Singapore (SG)

(73) Assignee: Continental Automotive Technologies GmbH, Hannover (DE)

(21) Appl. No.: 19/153,368

(22) PCT Filed: Jan. 29, 2024
(86) PCT No.: PCT/EP2024/052019

§ 371 Date: Aug. 4, 2025

(30) Foreign Application Priority Data
Feb. 8, 2023 (DE) 10 2023 201 032.1

(51) Int. Cl. H04W 52/02; H04W 76/28

(52) U.S. Cl. CPC H04W 52/0216; H04W 76/28

(57) ABSTRACT

The present disclosure relates to a method of wireless communication for updating discontinuous reception configuration in the wireless device, the wireless device being connected to a wireless network node. The method includes receiving a configuration message from the network node during a first active time period of a discontinuous reception cycle. The message includes at least a time offset parameter, scheduling a second active time period during a next inactive time period based on the received time offset, and receiving downlink data from said network node during the second active time period. The disclosure also contemplates an apparatus, a user equipment, a network node and a wireless system suitable to implement the method.

### CROSS REFERENCE TO RELATED APPLICATIONS

This application is the U.S. National Phase Application of PCT International Application No. PCT/EP2024/052019, filed Jan. 29, 2024, which claims priority to German Patent Application No. 10 2023 201 032.1, filed Feb. 8, 2023, the contents of such applications being incorporated by reference herein.

### TECHNICAL FIELD

The present disclosure relates to discontinuous reception (DRX) in wireless networks, and more particularly to methods and apparatus for updating and configuring discontinuous configuration in a user equipment.

### BACKGROUND

In order to limit power consumption in LTE (Long Term Evolution), 5G or NR (New Radio) telecommunication systems, 3GPP (Third Partnership Project) introduced DRX (Discontinuous Reception) mode.

Because downlink data may arrive at any time, a user equipment (UE) needs to constantly monitor Physical Downlink Control Channel (PDCCH) in order to check if there is downlink data available. This consumes a lot of power.

DRX makes it possible for the UE to reduce power consumption by discontinuously receiving PDCCH: UE periodically enters a sleeping state for a certain period of time (OFF duration) during which PDCCH is not monitored before waking up for another period of time (ON duration) to monitor PDCCH for possible downlink data. DRX thus allows a reduction of power consumption.

UE and network need to be synchronized to avoid the network trying to send data while the UE is in sleeping state. To this end, the network configures UE with a set of DRX parameters, including “onDurationTimer” and “inactivityTimer” as defined in 3GPP specification TS38.321. When a DRX period starts, UE stays active for a time period, referred as a “ON period”, which is configured through “onDurationTimer” parameter. If there is no PDCCH received during this time, the UE would enter DRX sleep state until the next active period. Whenever some activity occurs on PDCCH during the activity period, UE remains active and keeps monitoring for PDCCH for a duration configured through “inactivityTimer” parameter.

When a current active time expires, a user equipment must wait for the next active period to receive further download data. This increases latency for active data traffic and may degrade the user experience and service performance, especially for delay sensitive services like XR (augmented Reality).

There is therefore a need for a method that would reduce downlink data latency when using DRX.

### SUMMARY

In accordance with an aspect of the disclosure, there is provided a method of wireless communication by a wireless device for updating discontinuous reception configuration in said wireless device, said wireless device being connected to a wireless network node, the method comprising:
Receiving a configuration message from said network node during a first active time period of a discontinuous reception cycle, said message comprising at least a time offset parameter,
Based on said received time offset, scheduling a second active time period during a next inactive time period,
Receiving downlink data from said network node during said second active time period.

It is thus possible for a wireless device (e.g. user equipment, mobile station and the like) to schedule an additional active period during a previously scheduled inactive period when downlink data is expected during said inactive period. The wireless device may receive a message in which a time offset is provided by a network node (e.g. a base station, eNodeB, gNodeB and the like), said time offset defining a delay after which an additional active time period should be scheduled to receive downlink data. This way, the proposed method reduce latency by allowing downlink data reception without waiting for the initially configured active period.

According to an embodiment, the received time offset parameter is representative of a time delay between the receipt time of said parameter and the start time of said second active time period.

The time offset refers to a duration of a delay between the receipt of the message comprising said time offset and the start of the additional active time period.

According to an embodiment, the received time offset parameter is representative of a time delay between the end of the first active time period and the start time of said second active time period.

The time offset may refer to a duration of a delay between the end of the current active time period (i.e. the ON duration during which the time offset parameter was received) and the start of the additional active time period.

According to an embodiment, said second active time period is configured with a same duration as said first active time period.

The additional active time period has a default duration equal to the duration of the active time period during which the offset parameter was received. This avoids transmitting a duration in the configuration message, thus reducing bandwidth usage.

According to an embodiment, said message received further comprises a duration parameter for configuring a duration of said second active time period.

The duration of the active time period is provided in the configuration message along with the time offset parameter. A base station may thus fine tune the downlink monitoring time according to the expected downlink data to transmit. Such an arrangement may reduce power consumption in the user equipment.

According to an embodiment, the step of receiving downlink data comprises extending said second active time period by a duration corresponding to the elapsed time between the start time of the second active time period and the time of receipt of said downlink data.

In other words, the additional active time period is restarted (or shifted) when first transmitted downlink data is received by the user equipment during the scheduled active time period.

According to an embodiment, the method further comprises a step of receiving a sleep command during said second active time period for entering an inactive time period when no more downlink data is expected from said network node.

The additional active time period may end before its initial scheduled duration when no more downlink data is expected to be transmitted. This may be achieved by receiving a message from the network node comprising a command instructing the user equipment to end the current active period and enter a DRX sleep state until next active time period. This allows power saving by avoiding a user equipment to monitor a downlink channel when no downlink data is expected during the current ON duration.

According to an embodiment, the received configuration message is carried over MAC CE and/or a Physical Downlink Control Channel.

According to another aspect of the disclosure, it is proposed an apparatus for updating discontinuous reception configuration in a wireless device connected to a wireless network node, said apparatus comprising a processor coupled to a memory comprising computer program instructions stored thereon, said processor being configured by said instructions to perform the following acts:
Receiving a configuration message from said network node during a first active time period of a discontinuous reception cycle, said message comprising at least a time offset parameter,
Based on said received time offset, scheduling a second active time period during a next inactive time period,
Receiving downlink data from said network node during said second active time period.

The disclosure further contemplates a user equipment device comprising an apparatus as described above.

Another aspect of the disclosure relates to a method of wireless communication by a network node for configuring discontinuous reception in a wireless device connected to said network node, the method comprising:
Determining that downlink data is expected for said wireless device during a next inactive time period configured in said wireless device,
Transmitting a configuration message to said wireless device during a current active time period of a discontinuous reception cycle configured in said wireless device, said message comprising at least a time offset parameter,
Based on said received time offset, scheduling a second active time period for said wireless device during said next inactive time period,
Transmitting downlink data to said wireless device during said second active time period.

An additional active time period may be scheduled on demand by a network node (for example a base station, eNodeB or gNodeB and the like) when the network node determines that downlink data may become available for a wireless device (like a user equipment or a mobile station) during its next inactive time period.

The disclosure further contemplates a wireless network node for configuring discontinuous reception in a wireless device connected to said wireless network node, said apparatus comprising a processor coupled to a memory comprising computer program instructions stored thereon, said processor being configured by said instructions to perform the following acts:
Determining that downlink data is expected for said wireless device during a next inactive time period configured in said wireless device,
Transmitting a configuration message to said wireless device during a current active time period of a discontinuous reception cycle configured in said wireless device, said message comprising at least a time offset parameter,
Based on said received time offset, scheduling a second active time period for said wireless device during said next inactive time period,
Transmitting downlink data to said wireless device during said second active time period.

An aspect of the disclosure relates to a wireless communication system comprising a wireless network node and a wireless network node as describer hereinabove.

According to an embodiment, steps of the methods described hereinabove are determined by computer program instructions.

Consequently, an embodiment of the present disclosure relates to a computer program stored on an information medium, said program being suitable to be implemented in user equipment device and/or a wireless network node, or more generally in a computer, said program comprising instructions configured to implement steps of the method for updating discontinuous reception by a wireless device and/or of the method for configuring discontinuous reception in a wireless device which has just been described.

The program can use any programming language, and be in the form of source code, object code, or of code intermediate between source code and object code, such as in a partially compiled form, or in any other desirable form.

A further aspect contemplates a computer-readable information medium comprising computer program instructions for implementing steps of the methods mentioned hereinabove.

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being adapted to execute or to be used in the execution of the methods in question.

The advantages of the apparatus, user equipment, network node, wireless system, computer program and information medium are identical to those presented in relation with the corresponding methods according to any one of the embodiments mentioned hereinabove.

### BRIEF DESCRIPTION OF THE DRAWINGS

Other advantages and characteristics of aspects of the invention will be more clearly apparent on reading the following description, given by way of simple illustrative and nonlimiting example, and the appended drawings, among which:

FIG. 1 is a schematic diagram of a wireless communication system in which aspects of the method disclosed herein may be practiced, according to an embodiment,

FIG. 2 is a schematic diagram of an exemplary DRX cycle configuration on a user equipment,

FIG. 3 is a flow chart illustrating main steps of a method performed by a user equipment for updating a discontinuous reception configuration, according to an embodiment of the present disclosure,

FIG. 4 shows a DRX configuration comprising an additional active time period, according to an embodiment of the present disclosure,

FIG. 5 shows a DRX configuration comprising an additional active time period, according to an embodiment of the present disclosure,

FIG. 6 shows a reception of downlink data during an additional active time period configured during a DRX cycle, according to an embodiment of the present disclosure,

FIG. 7 is a flow chart illustrating main steps of a method performed by a base station for configuring discontinuous reception in a user equipment, according to an embodiment of the present disclosure,

FIG. 8 is a block diagram showing an architecture of an apparatus suitable to implement a method for updating discontinuous reception in a user equipment according to an embodiment,

FIG. 9 is a block diagram showing an architecture of an apparatus suitable to implement a method for configuring discontinuous reception in a user equipment according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of aspects of the invention.

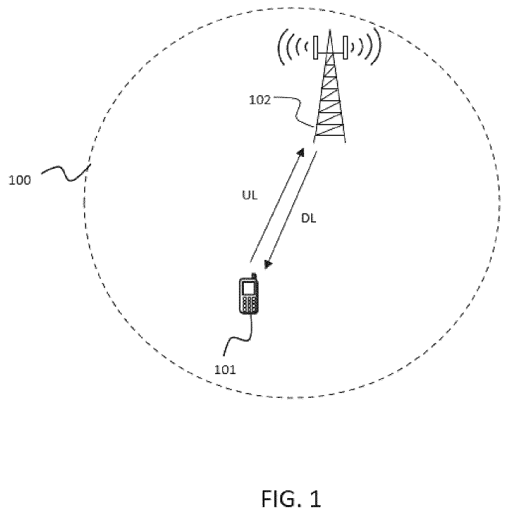

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as 5G or NR network. The wireless network 100 may include one or more network node, like a base station 102. The network node 102 may be referred as base station (BS), nodeB (NB), eNodeB (or eNB), gNodeB (or gNB), an access point or the like, depending on the wireless standard implemented. Base station 102 provide radio communication coverage for a particular geographic area called “cell”. User equipment 101 may communicate with base station 102 through radio signals to access a core communication network. The base station 102 may communicate with user equipment 101 using downlink (DL) and uplink (UL) radio channels.

User equipment 101 may be referred as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

In the following disclosure, reference will be made to user equipment 101 and base station 102 described above, with reference to FIG. 1.

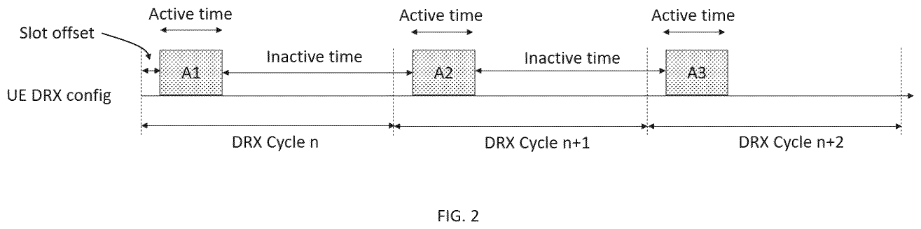

FIG. 2 is a schematic diagram of a DRX cycle configuration on a user equipment. Discontinuous reception (DRX) is a processing mode in a user equipment that aims at reducing power consumption. When using DRX, a user equipment periodically enters an active state (also referred as active time period, downlink monitoring period, or ON duration) to receive downlink data and signaling and then enters a sleep state (also referred as inactive state, inactive time period, or OFF duration) to stop monitoring on downlink data.

FIG. 2 shows an exemplary DRX cycle configured in a user equipment, said cycle comprising an active time period and an inactive time period. The DRX cycle is periodically repeated, leading to several ON durations noted A1, A2 and A3 separated by inactive time periods on FIG. 2.

DRX is configured by the base station using RRC (Radio Resource Control) signaling, e.g. RRC ConnectionReconfiguration or RRC Connection Setup. Among other, DRX parameters may include:
drx-onDurationTimer: the time during which user equipment should stay active after it wakes up (referenced as “Active Time” on FIG. 2). During this period, user equipment should monitor a physical downlink channel (e.g., PDCCH).
drx-inactivityTimer: this parameter corresponds to the delay during which the user equipment should remain in active state after being scheduled.
drx-SlotOffset defines the start of ON duration relative to the start of subframe boundary.

Once configured by the network, DRX cycles may be repeated until a new DRX configuration is received. Hence, user equipment may wake up even if there is no data to receive.

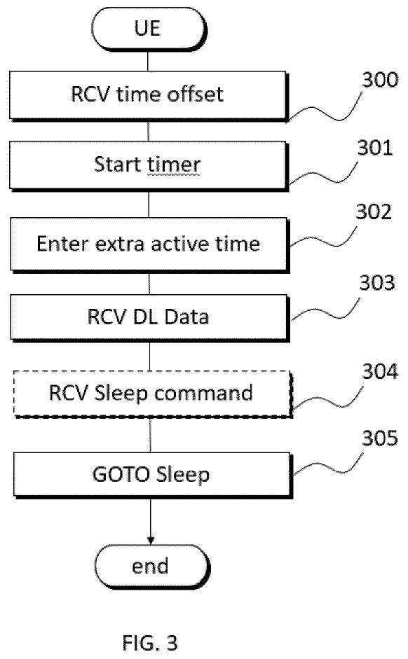

FIG. 3 is a flowchart showing main steps of a method performed by a user equipment for updating a discontinuous reception configuration according to an embodiment.

During a first step 300, the user equipment 101 receives a message from the base station 102 during an active downlink monitoring period of an initially configured DRX. The received message comprises at least a time offset parameter. Based on the received time offset, the user equipment 101 may determine a delay before entering an additional downlink monitoring period. According to an embodiment, the time offset value is configured by the base station 102 so that the additional downlink monitoring period takes place during the inactive period that immediately follows the active monitoring period during which the offset parameter is received.

According to an embodiment, the received time offset parameter may be an index value representative of a time duration. In such case, the user equipment 101 may use a matching table comprising associations between offset parameter values and corresponding time durations to find out a time duration in milliseconds corresponding to the received offset value.

According to an embodiment, the received time offset parameter may refer to an offset value given in milliseconds in the message.

In some embodiments, the received message may be carried over L1/L2 signaling (i.e. MAC CE and/or PDCCH).

The method further comprises a step 301 in which the user equipment 101 schedules an additional active downlink monitoring time period based on the received time offset. The additional ON period is scheduled to start after the expiration of a timer configured with a duration set according to the time offset received at step 300.

According to an embodiment, the user equipment 101 configures and starts the timer upon reception of the time offset parameter at step 300. The additional active duration thus starts when the time elapsed from the reception of the time offset value equals the received time offset value.

In some embodiments, the user equipment 101 configures and starts the timer upon expiration of the active time period during which the time offset value is received. The offset value thus refers to a time delay between the end of the current monitoring period and the starting the additional monitoring period.

When the timer fires, the user equipment 101 thus enters the additional active state at step 302 and starts monitoring downlink data period. According to an embodiment, user equipment 101 may start a second timer when entering active state to control the duration of said active period so that when the second timer expires, the additional monitoring period ends.

According to an embodiment, the second timer may be configured with a duration that corresponds to the duration of the latest monitoring period.

According to some embodiments, the configuration message received at step 300 further comprises a duration parameter for configuring a duration of said second active time period. The second timer is thus configured with the duration parameter received.

The method further comprises a step 303 in which the user equipment 101 receives downlink data during the additional downlink monitoring period started at step 301.

In some embodiments, the second timer may be restarted upon receipt of the first downlink data byte. The additional downlink monitoring period is thus extended by a duration that corresponds to the elapsed time between the start time of the additional active time period and the time of receipt of said downlink data.

According to an embodiment, the method may comprise a step 304 wherein the user equipment 101 receives a message from the base station 102 during the additional monitoring period, said message comprising a sleep command indicating that no more downlink data is expected to be transmitted by the base station 102 during the current additional active period. In some embodiment, the sleep command is transmitted using L1/L2 signaling, i.e., MAC CE and/or PDCCH.

The method further comprises a step 305 where the additional monitoring period ends and the user equipment 101 go back to sleep state until next DRC cycle.

In some embodiments, step 305 is triggered by the expiration of the second timer.

According to an embodiment, step 305 is triggered by the reception of a sleep command at step 304.

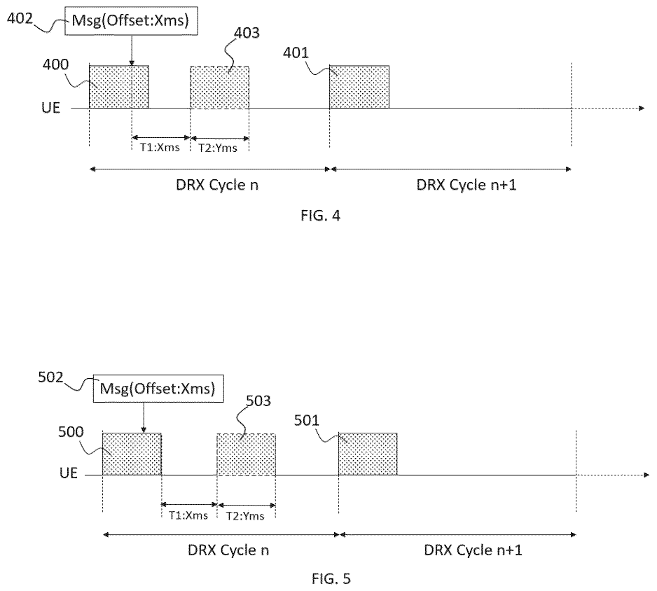

FIG. 4 is a schematic diagram of an exemplary DRX cycle configuration on a user equipment according to an embodiment.

FIG. 4 shows a first active time period 400 of a first DRX cycle n during which a user equipment monitors downlink channel and a second active time period 401 of a next DRX cycle n+1. FIG. 4 also shows a message 402 received by the user equipment during the active time period 400. The exemplary message 402, which may be transmitted on L1/L2 signaling by a base station, comprises a time offset parameter representative of a value of X milliseconds. Based on the received offset value, the user equipment schedules a timer T1 to expire X milliseconds after the receipt of the message 402. Upon expiration of timer T1, the user equipment enters an additional active monitoring period 403 and schedule a second timer T2. The purpose of timer T2 is to control the duration on the additional active downlink monitoring period 403, i.e., upon expiration of timer T2, the user equipment switches back to inactive state and stops monitoring downlink channel. In some examples, the duration of timer T2 may be equal to the duration of active time period 400 during which the message 402 is received. In some embodiments, the duration of timer T1 may be configured according to a duration parameter comprised in the message 402.

FIG. 5 is a schematic diagram of an exemplary DRX cycle configuration on a user equipment according to an embodiment.

FIG. 5 shows a first active time period 500 of a first DRX cycle n during which a user equipment monitors downlink channel and a second active time period 501 of a next DRX cycle n+1. FIG. 5 also shows a message 502 received by the user equipment during the active time period 500. The exemplary message 502, which may be transmitted on L1/L2 signaling by a base station, comprises a time offset parameter representative of a value of X milliseconds. Based on the received offset value, the user equipment schedules a timer T1 to expire X milliseconds after the end of the active time period 500 during which the message 502 is received. Upon expiration of timer T1, the user equipment enters an additional active monitoring period 503 and schedule a second timer T2. The purpose of timer T2 is to control the duration on the additional active downlink monitoring period 503, i.e., upon expiration of timer T2, the user equipment switches back to inactive state and stops monitoring downlink channel. In some examples, the duration of timer T2 may be equal to the duration of active time period 500 during which the message 502 is received. In some embodiments, the duration of timer T1 may be configured according to a duration parameter comprised in the message 502.

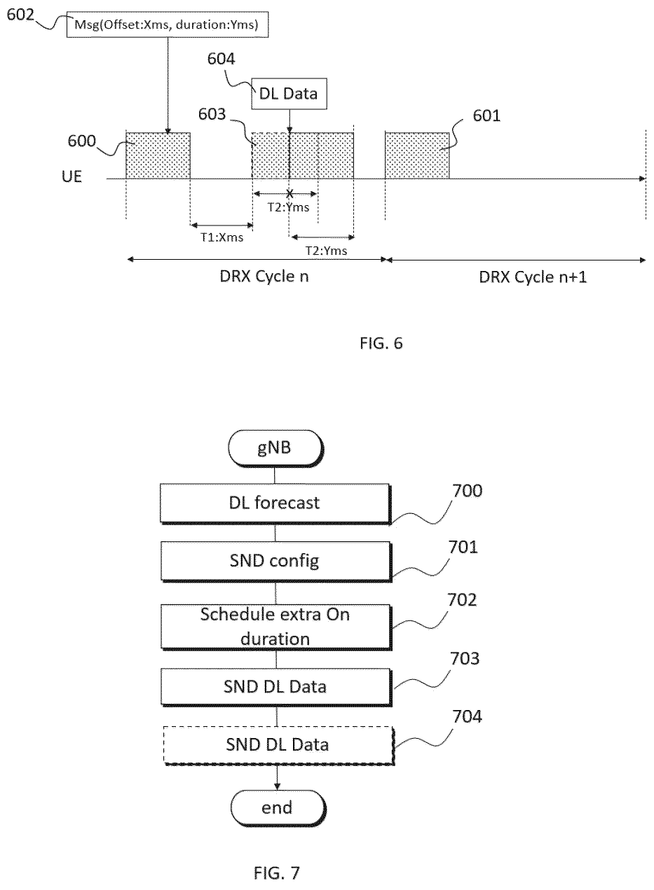

FIG. 6 is a schematic diagram of an exemplary DRX cycle configuration on a user equipment according to an embodiment.

FIG. 6 shows a first active time period 600 of a first DRX cycle n during which a user equipment monitors downlink channel and a second active time period 601 of a next DRX cycle n+1.

FIG. 6 also shows a message 602 received by the user equipment during the active time period 600. The exemplary message 602, which may be transmitted on L1/L2 signaling by a base station, comprises a time offset parameter representative of a value of X milliseconds and a duration parameter of Y milliseconds. Based on the received offset value, the user equipment schedules a timer T1 to expire X milliseconds after the end of the active time period 600 during which the message 602 is received. Upon expiration of timer T1, the user equipment enters an additional active monitoring period 603 and schedule a second timer T2 using the duration provided in the message 602. The purpose of timer T2 is to control the duration on the additional active downlink monitoring period 603, i.e., upon expiration of timer T2, the user equipment should switch back to inactive state. The base station may fine tune the duration T2 according to the amount of data that is expected to be transmitted to the user equipment.

FIG. 6 further shows downlink data 604 received during the additional active monitoring time period 603. Upon receipt of said downlink data 604, the timer T2 may be restarted so that the total duration of the additional active period is extended.

FIG. 7 is a flowchart showing main steps of a method performed by a network node for configuring discontinuous reception in a user equipment, according to an embodiment.

During a first step 700, the base station 102 referenced on FIG. 1 may determine that downlink data is expected outside the user equipment 101 active time. The determination may be achieved by mapping user equipment DRX configuration with traffic history, traffic flows and associated periodicity, traffic data burst rate analysis and the like.

When downlink data is expected for the user equipment 101 during its next inactive time period, the base station 102 may perform a step 701 wherein it determines characteristics of an additional active time period that would allow downlink data transmission at short notice. In particular, the base station 102 may determine at least a time offset parameter for starting an additional active time period within an inactive period following a currently active period. The time offset parameter may refer to the delay before the expected data is ready for transmission to the user equipment, or the delay between the end of the current active time period and the availability of the expected data to transmit.

The base station 102 may then transmit determined time offset to the user equipment 101 using L1/L2 signaling, i.e., MAC CE and/or PDCCH.

According to an embodiment, the base station 102 may further determine a duration parameter representative of the time required to transmit the expected data. If such a duration is determined, it is included in the message transmitted to the user equipment 101 with the time offset parameter.

The method further comprises a step 702 in which the base station 102 schedules an additional active time period associated with the user equipment 101 based on the time offset determined at step 701. The additional active time is scheduled to start after the expiration of a timer configured with a duration set according to the time offset.

According to an embodiment, the base station 102 configures and starts said timer when sending the time offset parameter at step 701. The additional active duration thus starts when the time elapsed from the reception of the time offset value equals the received time offset value. In some embodiments, the base station 102 configures and starts the timer upon expiration of the current active time period, i.e., during after the active time period during which the time offset parameter is sent to the user equipment. The offset value thus refers to a time delay between the end of the current monitoring period and the starting the additional monitoring period.

When the timer fires, the base station 102 thus knows that the user equipment 101 has entered the configured additional active time period. According to an embodiment, the base station 102 may start a second timer when it is determined that the user equipment 101 has entered the additional active period, said second timer making it possible to monitor the duration of the additional active period: when the second timer expires, the base station 102 knows that the additional monitoring period configured in the user equipment 101 ends.

If no duration parameter value is transmitted to the user equipment at step 701, the second timer may be configured with a duration that corresponds to the duration of the latest active time period. Otherwise, the second timer may be configured with the determined duration parameter.

The method may further comprise a step 703 of transmitting downlink data to the user equipment 101 during the scheduled additional active time period.

In some embodiments, the second timer for monitoring the additional active time duration may be restarted upon sending of the downlink data. The additional active time period is thus extended by a duration that corresponds to the elapsed time between the start time of the additional active time period and the time of receipt of said downlink data.

According to an embodiment, the method may comprise a step 704 wherein the base station 102 detects that no more downlink data is expected so far for the user equipment 101, and transmits a message to the user equipment 101 comprising a sleep command indicating that no more downlink data is expected to be transmitted during the current additional active period. In some embodiment, said message is transmitted using L1/L2 signaling, i.e., MAC CE and/or PDCCH.

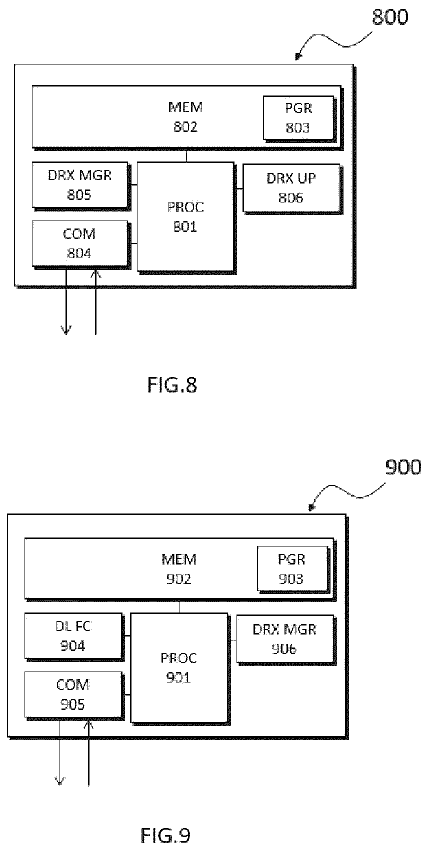

FIG. 8 shows a schematic architecture of an apparatus 800 suitable to implement a method of wireless communication for updating a discontinuous reception configuration by a user equipment device, according to an embodiment.

The apparatus 800 comprises a processor 801 and a memory 802, for example a Random Access Memory (RAM). The processor 801 may be controlled by a computer program 803 stored in the memory 802 comprising instructions configured to implement a method of wireless communication for updating discontinuous reception configuration according to an embodiment.

More precisely, the computer program 803 comprises instructions configured to implement steps of receiving a configuration message from a network node during a first active time period of a discontinuous reception cycle, said message comprising at least a time offset parameter, scheduling a second active time period during a next inactive time period based on said received time offset, and receiving downlink data from said network node during said second active time period.

On initialization, the computer program instructions 803 may be loaded into the memory 802 before being executed by the processor 801. The processor 801 implements the steps of the method according to the instructions of the computer program 803.

The apparatus 800 comprises a wireless communication unit 804 configured to exchange data using radio signals. The communication unit 804 may be a 3G, 4G, 5G, NR, WiFi or Wimax transceiver suitable for establishing connections and exchange data with one or more network nodes of a wireless network. The communication unit 804 may be configured to receive downlink data transmitted by a network node, in particular a configuration message from a network node during a first active time period of a discontinuous reception cycle, said message comprising at least a time offset parameter.

The apparatus 800 further comprises a DRX manager module 805 configured to apply at least one DRX configuration received from a base station through the communication unit 904. The DRX manager module may be implemented by computer program instructions configured to periodically activate and deactivate a receiver unit of the communication module 804 according to said DRX configuration parameters.

The apparatus 800 may also include a DRX configuration updater module 806 configured to update an active DRX configuration of the DRX manager 805. The DRX updater module may be implemented by computer program instructions configured to obtain at least a time offset received by the communication module 804 during a DRX active time period and schedule an additional active time period based on the received time offset in the DRX manager module 805.

In some embodiments, the DRX configuration updater module 806 may be further configured by computer program instructions to obtain an active time duration received by the communication module 804 during a DRX active time period, and to schedule an additional active time period based on the obtained duration time offset in the DRX manager module 805.

According to an embodiment, the apparatus 800 is included in a wireless device, for example a user equipment like a smartphone, a telecommunication unit of a vehicle, a computer, an IoT device and the like.

FIG. 9 shows a schematic architecture of an apparatus 900 suitable to implement a method of wireless communication for configuring discontinuous reception in a user equipment, according to an embodiment.

The apparatus 900 comprises a processor 901 and a memory 902, for example a Random Access Memory (RAM). The processor 901 may be controlled by a computer program 903 stored in the memory 902 comprising instructions configured to implement a method of wireless communication for configuring discontinuous reception in a wireless device according to an embodiment.

More precisely, the computer program 903 comprises instructions configured to implement steps of determining that downlink data is expected for said wireless device during a next inactive time period configured in said wireless device, transmitting a configuration message to said wireless device during a current active time period of a discontinuous reception cycle configured in said wireless device, said message comprising at least a time offset parameter, and scheduling a second active time period for said wireless device during said next inactive time period based on said received time offset.

The apparatus 900 comprises a downlink data forecast module 904 configured to determine that downlink data is expected for a user equipment during a next inactive time period configured in user equipment. The module 904 may be implemented by computer program instructions configured to determine traffic flow characteristics, like traffic flow periodicity, data burst rate and duration, and the like, and to determine that downlink data is expected for a user equipment during a next DRX inactive time period configured in said user equipment. The downlink data forecast module may be further configured by computer program instructions to determine a time delay between data arrival and a duration for transmitting the expected data.

The apparatus 900 comprises a wireless communication unit 905 configured to exchange data using radio signals. The communication unit 905 may be a 3G, 4G, 5G, NR, WiFi or Wimax transceiver suitable for establishing connections and for exchanging data with one or more user equipment of a wireless network. The communication unit 905 may be configured to transmit a configuration message over L1/L2 signaling to a user equipment during a first DRX active time period of said user equipment, said configuration message comprising at least a time offset parameter determined by the downlink data forecast module 904. According to an embodiment, the communication unit 905 is further configured to transmit a configuration message further comprising the transmit duration determined by the forecast module 904.

The apparatus 900 further comprises a DRX manager module 906 configured to monitor and configure the DRX state of a user equipment. The DRX manager module may be implemented by computer program instructions configured to manage a set of timers for determining the DRX state of a user equipment based on at least one active DRX configuration configured in said user equipment. The DRX manager module 906 may be further configured by computer program instructions to determine the start time and duration of an additional DRX active state corresponding to the DRX configuration update sent to a user equipment by the communication unit 905, and to notify the communication 905 when the user equipment is entering said additional DRX active time so that the communication module can send downlink data to the user equipment during said additional DRX active time.

According to an embodiment, the apparatus 900 is included in a wireless network node, for example a base station, eNodeB, gNodeB and the like.

The present disclosure also contemplates a wireless communication system for updating discontinuous reception, said system comprising a user equipment comprising the apparatus 800 and a base station comprising the apparatus 900.

1. A method of wireless communication by a wireless device for updating discontinuous reception configuration in said wireless device, said wireless device being connected to a wireless network node, the method comprising:
Receiving a configuration message from said network node during a first active time period of a discontinuous reception cycle, said message comprising at least a time offset parameter,
Based on said received time offset, scheduling a second active time period during a next inactive time period,
Receiving downlink data from said network node during said second active time period.

2. A method according to claim 1 wherein said time offset parameter is representative of a delay between the reception of said parameter and the start of said second active time period.

3. A method according to claim 1 wherein said time offset parameter is representative of a delay between the end of the first active time period and the start of said second active time period.

4. A method according to claim 1, wherein said second active time period is configured with a same duration as said first active time period.

5. A method according to claim 1, wherein said message received further comprises a duration parameter for configuring a duration of said second active time period.

6. A method according to claim 4, wherein receiving downlink data comprises extending said second active time period by a duration corresponding to the elapsed time between the start time of the second active time period and the time of receipt of said downlink data.

7. A method according to claim 1, wherein the method further comprises a step of receiving a sleep command during said second active time period when no more downlink data is expected from said network node.

8. A method according to claim 1, wherein said configuration message is carried over MAC CE and/or a Physical Downlink Control Channel.

9. An apparatus for updating discontinuous reception configuration in a wireless device connected to a wireless network node, said apparatus comprising a processor coupled to a memory comprising computer program instructions stored thereon, said processor being configured by said instructions to perform the following acts:
Receiving a configuration message from said network node during a first active time period of a discontinuous reception cycle, said message comprising at least a time offset parameter,
Based on said received time offset, scheduling a second active time period during a next inactive time period,
Receiving downlink data from said network node during said second active time period.

10. A user equipment device comprising an apparatus according to claim 9.

11. A method of wireless communication by a network node for configuring discontinuous reception in a wireless device connected to said network node, the method comprising:
Determining that downlink data is expected for said wireless device during a next inactive time period configured in said wireless device,
Transmitting a configuration message to said wireless device during a current active time period of a discontinuous reception cycle configured in said wireless device, said message comprising at least a time offset parameter,
Based on said received time offset, scheduling a second active time period for said wireless device during said next inactive time period,
Transmitting downlink data to said wireless device during said second active time period.

12. A wireless network node for configuring discontinuous reception in a wireless device connected to said wireless network node, said apparatus comprising a processor coupled to a memory comprising computer program instructions stored thereon, said processor being configured by said instructions to perform the following acts:
Determining that downlink data is expected for said wireless device during a next inactive time period configured in said wireless device,
Transmitting a configuration message to said wireless device during a current active time period of a discontinuous reception cycle configured in said wireless device, said message comprising at least a time offset parameter,
Based on said received time offset, scheduling a second active time period for said wireless device during said next inactive time period,
Transmitting downlink data to said wireless device during said second active time period.

13. A wireless communication system comprising a wireless network node for configuring discontinuous reception in a wireless device connected to said wireless network node, said apparatus comprising a processor coupled to a memory comprising computer program instructions stored thereon, said processor being configured by said instructions to perform the following acts:
Determining that downlink data is expected for said wireless device during a next inactive time period configured in said wireless device,
Transmitting a configuration message to said wireless device during a current active time period of a discontinuous reception cycle configured in said wireless device, said message comprising at least a time offset parameter,
Based on said received time offset, scheduling a second active time period for said wireless device during said next inactive time period,
Transmitting downlink data to said wireless device during said second active time period, for configuring a user equipment according to claim 11.

14. A computer program product comprising instructions for implementing a method for updating a discontinuous reception configuration according to claim 1, when said program is executed by a processor.

15. A non-transitory computer-readable storage medium comprising computer program instruction stored thereon for implementing a method for updating a discontinuous reception configuration according to claim 1.

16. A non-transitory computer-readable storage medium comprising computer program instruction stored thereon for implementing instructions for a method for configuring discontinuous reception in a wireless device according to claim 10.

17. A computer program product comprising instructions for implementing a method for configuring discontinuous reception in a wireless device according to claim 10, when said program is executed by a processor.
